(19) United States
(12) Patent Application Publication
(10) Pub. No.: US 2026/0261649 A1
(43) Pub. Date: Sep. 3, 2026

(54) METHOD AND APPARATUS FOR VIDEO CODING

(71) Applicant: MEDIATEK INC., Hsinchu City (TW)

(72) Inventors: Olena CHUBACH, San Jose, CA (US); Yi-Wen CHEN, San Jose, CA (US); Ching-Yeh CHEN, Hsinchu City (TW)

(21) Appl. No.: 18/994,816

(22) PCT Filed: Aug. 9, 2023
(86) PCT No.: PCT/CN2023/112056

§ 371 Date: Jan. 15, 2025

Related U.S. Application Data
(60) Provisional application No. 63/370,803, filed on Aug. 9, 2022.

(51) Int. Cl. H04N 19/105; H04N 19/174; H04N 19/176; H04N 19/70

(52) U.S. Cl. CPC H04N 19/105; H04N 19/174; H04N 19/176; H04N 19/70

(57) ABSTRACT

Aspects of the disclosure provide methods, apparatuses, and a non-transitory computer-readable storage medium for video coding. An apparatus includes processing circuitry that decodes prediction information of a current block in a current picture that is a part of a coded video sequence. The prediction information indicates a local illumination compensation (LIC) mode for the current block. Multiple reference lines of the current block are available for LIC parameters estimation of the LIC mode. The processing circuitry selects one or more reference lines from the multiple reference lines of the current block, estimates the LIC parameters of the LIC mode based on the one or more reference lines, and decodes the current block based on the estimated LIC parameters of the LIC mode.

### INCORPORATION BY REFERENCE

This present disclosure claims the benefit of priority to U.S. Provisional Application No. 63/370,803, “LOCAL ILLUMINATION COMPENSATION WITH MULTIPLE TEMPLATE OPTIONS AND SLOPE ADJUSTMENT POSSIBILITY” filed on Aug. 9, 2022, which is incorporated by reference herein in its entirety.

### TECHNICAL FIELD

The present disclosure describes embodiments generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

One purpose of video coding (e.g., encoding and/or decoding) can be a reduction of redundancy in an input video signal, through a compression. The compression can help reduce bandwidth or storage space requirements. Both lossless and lossy compression, as well as a combination thereof can be employed.

Video coding can be performed using an inter-picture prediction with motion compensation. Motion compensation can be a lossy compression technique and can relate to techniques where a block of sample data from a previously reconstructed picture or part thereof (reference picture), after being spatially shifted in a direction indicated by a motion vector (MV henceforth), is used for the prediction of a newly reconstructed picture or picture part.

In the present invention, methods to improve local illumination compensation (LIC) mode are disclosed.

### SUMMARY

Aspects of the disclosure provide a method for video coding. The method includes decoding prediction information of a current block in a current picture that is a part of a coded video sequence. The prediction information indicates a local illumination compensation (LIC) mode for the current block. Multiple reference lines of the current block are available for LIC parameters estimation of the LIC mode. The method includes selecting one or more reference lines from the multiple reference lines of the current block, estimating the LIC parameters of the LIC mode based on the one or more reference lines, and decoding the current block based on the estimated LIC parameters of the LIC mode.

In an embodiment, the prediction information includes a first syntax element indicating that the multiple reference lines of the current block are available for the LIC parameters estimation of the LIC mode.

In an embodiment, the prediction information includes a second syntax element indicating a number of the multiple reference lines available for the LIC parameters estimation of the LIC mode.

In an embodiment, the prediction information includes a third syntax element indicating a number of the one or more reference lines selected for the LIC parameters estimation of the LIC mode.

In an embodiment, the one or more reference lines includes a first subset and a second subset of the multiple reference lines for a top reference template and a left reference template of the current block, respectively. The first subset of the multiple reference lines is different from the second subset of the multiple reference lines.

In an embodiment, the one or more reference lines includes a first subset and a second subset of the multiple reference lines for a luma component and a chroma component of the current block, respectively. The first subset of the multiple reference lines is different from the second subset of the multiple reference lines.

In an embodiment, the one or more reference lines includes a subset of the multiple reference lines that is applied to at least two of one luma component and two chroma components of the current block. The prediction information includes a fourth syntax indicating the subset of the multiple reference lines.

In an embodiment, the prediction information indicates the one or more selected reference lines.

According to some embodiments of the disclosure, the estimating includes calculating multiple sets of the LIC parameters based on the one or more reference lines and determining the LIC parameters of the LIC mode based on at least one of the multiple sets of the LIC parameters.

In an embodiment, the calculating includes calculating a separate one of the multiple sets of the LIC parameters for each of the one or more reference lines. The determining includes determining the LIC parameters of the LIC mode based on a weighted average of the multiple sets of the LIC parameters.

In an embodiment, the calculating includes splitting samples of the one or more reference lines into a plurality of groups of samples based on a threshold and calculating the multiple sets of the LIC parameters based on the plurality of groups of samples. The determining includes selecting one of the multiple sets of the LIC parameters as the LIC parameters of the LIC mode.

In an embodiment, the calculating includes calculating the multiple sets of the LIC parameters based on multiple rounds of refinement process on the LIC parameters. The determining includes determining the LIC parameters of a final round of the multiple rounds as the LIC parameter of the LIC model.

According to some embodiments of the disclosure, the estimating includes calculating a slope parameter of the LIC model based on the one or more reference lines and adjusting the slope parameter based on a slope adjustment value.

In an embodiment, the slope adjustment value is selected from a predefined set of adjustment values.

In an embodiment, the slope adjustment value is signaled in the prediction information.

In an embodiment, the prediction includes a fifth syntax element indicating whether signaling the slope adjustment value is enabled.

According to some embodiments of the disclosure, the current block is coded in a sub-block mode, and the estimating includes calculating the LIC parameters for each sub-block of the current block and/or adjusting the LIC parameters of each sub-block based on at least one LIC parameter adjustment value.

In an embodiment, the adjusting includes determining multiple adjustment values each for a separate sub-block and determining a final candidate value based on the multiple adjustment values.

Aspects of the disclosure provide an apparatus for video coding. The apparatus includes processing circuitry that decodes prediction information of a current block in a current picture that is a part of a coded video sequence. The prediction information indicates LIC mode for the current block. Multiple reference lines of the current block are available for LIC parameters estimation of the LIC mode. The processing circuitry selects one or more reference lines from the multiple reference lines of the current block, estimates the LIC parameters of the LIC mode based on the one or more reference lines, and decodes the current block based on the estimated LIC parameters of the LIC mode.

Aspects of the disclosure provide a method of video coding at an encoder. The method includes generating prediction information of a current block in a current picture that is a part of a coded video sequence. The prediction information indicating an LIC mode for the current block. Multiple reference lines of the current block being available for LIC parameters estimation of the LIC mode. The method further includes selecting one or more reference lines from the multiple reference lines of the current block, estimating the LIC parameters of the LIC mode based on the one or more reference lines, and encoding the current block based on the estimated LIC parameters of the LIC mode.

Aspects of the disclosure also provide a non-transitory computer-readable medium storing instructions which when executed by a computer for video decoding cause the computer to perform the method for video decoding.

### BRIEF DESCRIPTION OF THE DRAWINGS

Further features, the nature, and various advantages of the disclosed subject matter will be more apparent from the following detailed description and the accompanying drawings in which:

FIGS. 1A and 1B show exemplary 4-parameter and 6-parameter affine models, respectively, according to embodiments of the disclosure;

FIG. 1C shows an exemplary affine motion compensation according to embodiments of the disclosure;

FIG. 2A shows an example of deriving a local illumination compensation (LIC) model for a coding block coded in an LIC mode according to embodiments of the disclosure;

FIGS. 2B and 2C show examples of deriving LIC models for a non-subblock mode and a sub-block mode, respectively, according to embodiments of the disclosure;

FIGS. 3A-3C shows three syntax tables for an LIC mode, respectively, according to embodiments of the disclosure;

FIG. 4A shows an example of deriving an LIC model using multiple reference lines according to embodiments of the disclosure;

FIG. 4B shows an example of adjusting a slope parameter of an LIC model according to embodiments of the disclosure;

FIG. 4C shows two examples of adjusting LIC parameters of sub-blocks according to embodiments of the disclosure;

FIG. 5 shows a flowchart illustrating a process of decoding a current block according to embodiments of the disclosure;

FIG. 6 shows a block diagram of an encoder according to embodiments of the disclosure;

FIG. 7 shows a block diagram of a decoder according to embodiments of the disclosure;

FIG. 8 is a schematic illustration of a computer system according to embodiments of the disclosure; and

FIG. 9 shows a flowchart illustrating a process of encoding a current block according to embodiments of the disclosure.

### DETAILED DESCRIPTION OF EMBODIMENTS

### I. Affine Prediction

In high efficiency video coding (HEVC), only translation motion model can be applied to motion compensation. However, in some cases, there are non-translational motion types, e.g., zoom in/out, rotation, perspective motion, and other irregular motion. In versatile video coding (VVC), affine prediction (e.g., affine merge mode, affine inter mode) can be used to compensate the non-translational motion.

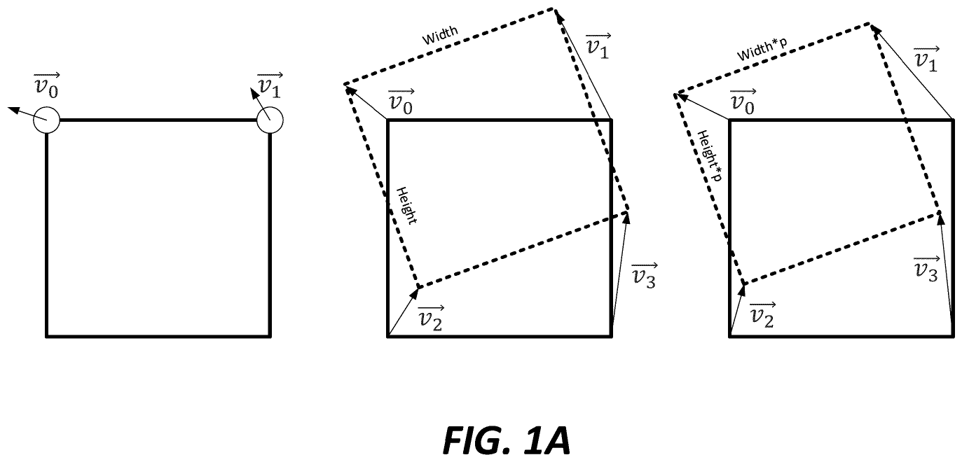

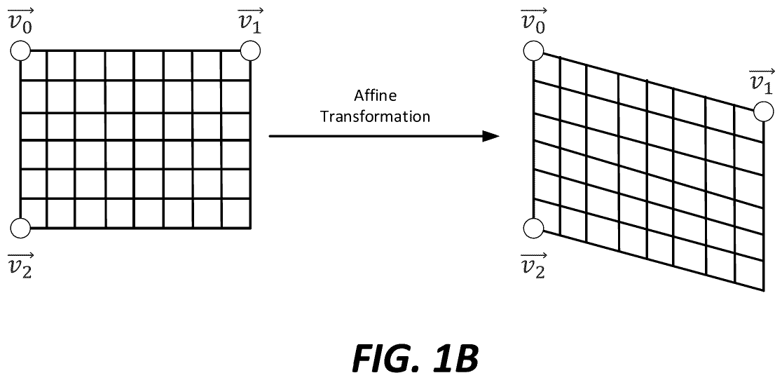

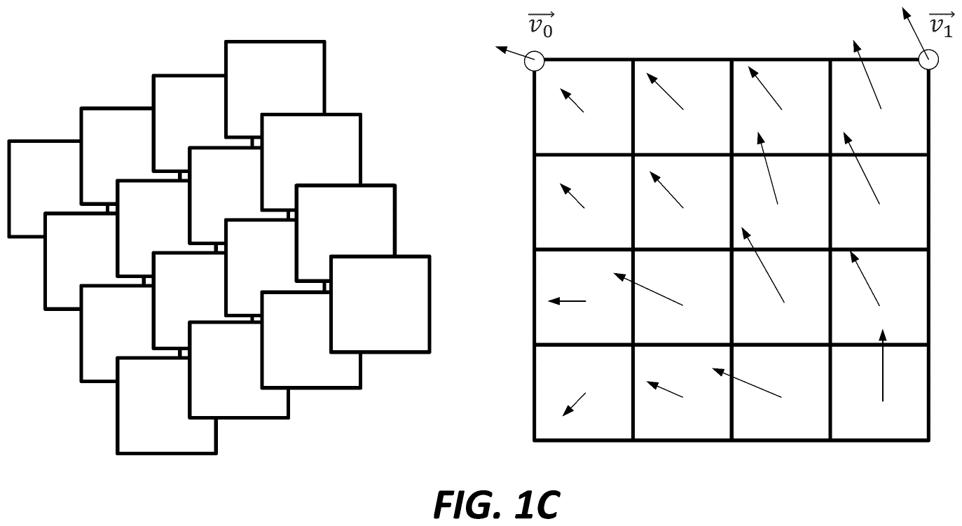

FIGS. 1A and 1B show exemplary 4-parameter and 6-parameter affine models, respectively, according to embodiments of the disclosure. In the 4-parameter affine model, there are two control point motion vectors (MVs) \vec{v₀} and \vec{v₁}. As shown in FIG. 1A, a transformed 4-parameter affine model can still be in a rectangular shape represented by Eq. 1.

$$\{ \begin{matrix}{v}_{x} = \frac{( {v}_{1 x} - {v}_{0 x} )}{w} x - \frac{( {v}_{1 y} - {v}_{0 y} )}{w} y + {v}_{0 x} \\ {v}_{y} = \frac{( {v}_{1 y} - {v}_{0 y} )}{w} x + \frac{( {v}_{1 x} - {v}_{0 x} )}{w} y + {v}_{0 y}\end{matrix} \qquad ( Eq . l )$$

In the 6-parameter affine model, there are three control point MVs \vec{v₀}, \vec{v₁}, and \vec{v₂}. As shown in FIG. 1B, a transformed 6-parameter affine model can form a parallelogram represented by Eq. 2.

$$\{ \begin{matrix}{v}_{x} = \frac{( {v}_{1 x} - {v}_{0 x} )}{w} x + \frac{( {v}_{2 x} - {v}_{0 x} )}{h} y + {v}_{0 x} \\ {v}_{y} = \frac{( {v}_{1 y} - {v}_{0 y} )}{w} x + \frac{( {v}_{2 y} - {v}_{0 y} )}{h} y + {v}_{0 y}\end{matrix} \qquad ( Eq . 2 )$$

In affine motion compensation, after the control point MVs are decoded, the MV of each 4×4 subblock can be derived by using an affine motion model.

FIG. 1C shows an exemplary affine motion compensation according to embodiments of the disclosure. MV of a center sample can represent an MV of an entire 4×4 subblock. The center sample can be positioned at (2, 2) within the 4×4 subblock, and (0, 0) means a top left sample of the 4×4 subblock. The MV precision of each 4×4 subblock can be 1/16 luma sample. For each 4×4 subblock, block-based motion compensation can be performed.

### II. Local Illumination Compensation (LIC)

LIC is an inter prediction technique to model a local illumination variation between a current block and a prediction block of the current block as a function of that between a current block template and a reference block template. The function can form a linear equation y=α*p[x]+β to compensate illumination changes, where parameters of the function can be denoted by a scale (or slope) α and an offset β, and p[x] is a reference sample pointed to by an MV at a location x on a reference picture of the current block. Since α and β can be derived based on the current block template and the reference block template, no signaling overhead is required for them, except that an LIC flag is signaled for advanced motion vector prediction (AMVP) mode to indicate the use of LIC.

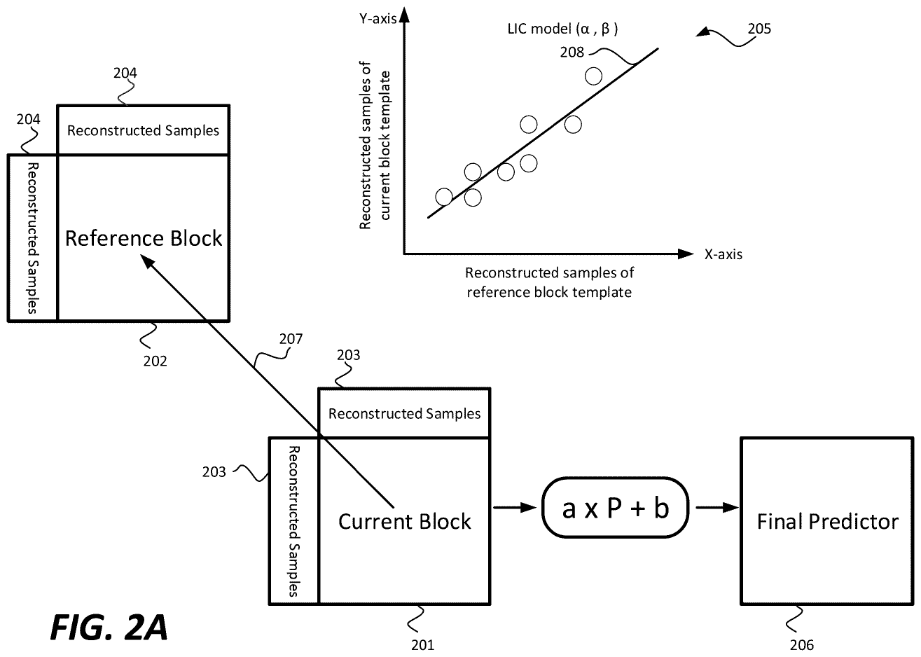

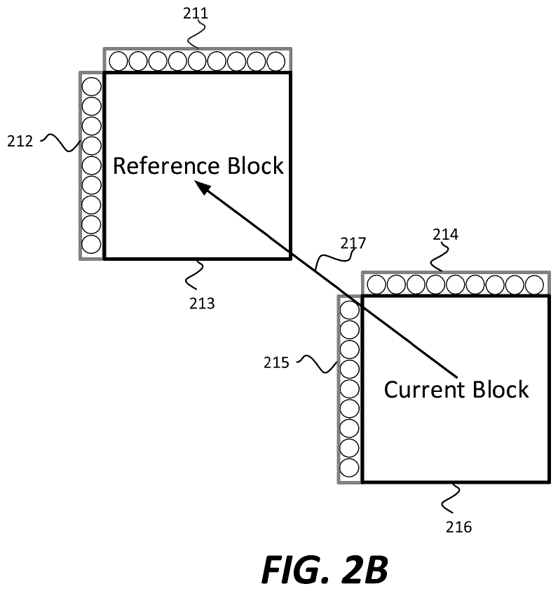

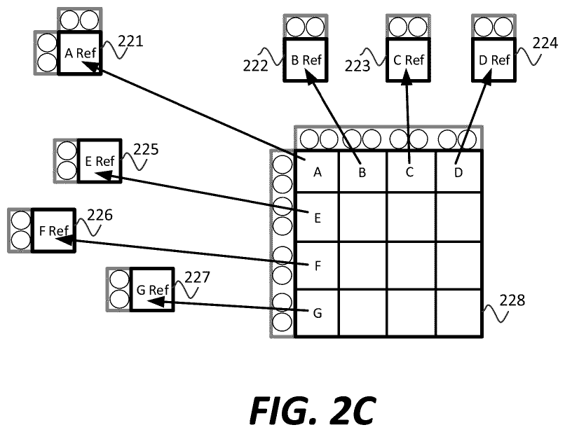

FIG. 2A shows an example of deriving an LIC model for a coding block coded in an LIC mode according to embodiments of the disclosure. In FIG. 2A, the LIC parameters α and β of the LIC model 208 can be derived based on a plot 205, where X-axis represents reconstructed samples of a reference block template 204 of a reference block 202, and Y-axis represents reconstructed samples of a current block template 203 of a current block 201. An MV 207 can point from the current block 201 to the reference block 202. After the LIC parameters α and β are derived, a final predictor 206 can be generated based on the linear equation α×P+β, where P represents the reference block 202.

FIGS. 2B and 2C show examples of deriving LIC models for a non-subblock mode and a sub-block mode, respectively, according to embodiments of the disclosure.

For the non-subblock mode in FIG. 2B, an LIC model can be derived based on top boundary pixels 211 and left boundary pixels 212 of an entire reference block 213 and top boundary pixels 214 and left boundary pixels 215 of an entire current block 216. The derived single LIC model can be applied to the entire current block 216, from which an MV 217 points to the reference block 213. It is noted that one line of samples on top and one column of samples on the left of the current and reference coding units (CUs) can be used as templates. If one of the top or left template is not available, the LIC scale and offset parameters can be obtained from the samples of the available template.

For the sub-block mode (such as affine mode) in FIG. 2C, an LIC model can be derived based on the reference blocks 221-227 of all top and left boundary sub-blocks A-G of a current block 228. The derived single LIC model can be applied to the entire current block 228. This means that sub-blocks are not independent. It is noted that in the sub-block mode and/or non-subblock mode, it is not necessary to use every sample for the LIC parameters estimation. For example, top row and left column are subsampled depending on min (W, H), which represents a minimum of a width and a height of a current block. At most 2*min (W, H) samples (an exact value can depend on a value of the min (W, H)) can be used. It may be always the same amount from top row and left column, without considering W to H ratio of the block.

In an embodiment, when an in-loop luma reshaping is used, an inverse reshaping can be applied to neighboring samples of a current CU prior to the LIC parameter derivation. This is because the neighboring samples of the current CU are in the reshaped domain, and the reference picture samples of the current CU are in the original (non-reshaped) domain.

In an embodiment, the LIC scale and offset parameters can be defined and applied for each component separately.

In an embodiment, LIC can be disabled (or not applied) for a combined inter/intra prediction (CIIP) block, and intra block copy (IBC) block, or a bi-prediction block.

In an embodiment, LIC can be applied to a sub-block mode, where the LIC parameters can be derived based on samples derived on a sub-block basis.

In an embodiment, the LIC flag can be included as a part of motion information in addition to MVs and reference indices.

In an embodiment, the LIC flag can be inherited for history-based motion vector prediction (HMVP). In the HMVP, motion information of previous blocks can be stored in a HMVP table. The HMVP table can be reset (or emptied) when a new CTU row is encountered. The HMVP table can be maintained during the encoding and/or decoding process. An MV can be from the HMVP table and a reference block of a current block can be determined based on the MV. An LIC flag of the reference block can be used as the LIC flag of the current block.

In an embodiment, when a merge candidate list is constructed, the LIC flag can be inherited (or derived) from neighboring blocks for merge candidates in the merge candidate list. For example, a neighboring block of a current block can be determined based on a merge candidate in the merge candidate list, and an LIC flag of the neighboring block can be used as the LIC flag of a current block.

In an embodiment, the LIC flag is not considered for motion vector pruning in generating a merge candidate list.

In an embodiment, the LIC flag does not have a temporal inheritance.

In an embodiment, the LIC flag is not stored in an MV buffer of a reference picture. In such an embodiment, the LIC flag can be always set to false for temporal motion vector predictor (TMVP).

In an embodiment, the LIC flag is set to false for bi-directional merge candidates, such as pair-wise average candidate or zero motion candidates.

In an embodiment, the LIC flag is context coded with a single context. When LIC is not applied, the LIC flag is not signaled.

In an embodiment, the scale parameter α can range between 0 and 128, and the offset parameter β can range between −512 and 511 (for the case of 10 bit content). It is noted that the ranges of the parameters can vary for different bitdepths.

In an embodiment, to derive LIC linear model parameters, a linear least square method can be utilized, in which the following operations can be performed on per CU: (i) multiplication; (ii) addition; and (iii) shift. Numbers of multiplication, addition, and/or shift can depend on a width and/or a length of a current block. For example, the numbers of multiplication, addition, and shift can be 2*min(width, height)+4, 4*min(width, height)+4, and 12, respectively.

To apply linear model, one multiplication and one addition can be used per sample, which can be done at a reconstruction stage when a prediction is added to the residual.

In an embodiment, one or more conditions need to be checked to determine whether the LIC is to be applied. For example, in an encoder, for an integer motion vector (IMV) mode, the LIC is not tested if a rate distortion (RD) check cost of a non-LIC IMV AMVP mode is 1.2 times worse than a current best RD cost or a size of a block is less than 32 luma samples. This can be referred to as skip RD check for LIC.

In an embodiment, the LIC is not used with a bi-prediction block in a merge mode.

In an embodiment, geometric mode, IBC mode, CIIP mode are not used with the LIC.

In an embodiment, a bi-prediction mode is not used with the LIC.

In an embodiment, if a slice is non-intra and LIC is enabled on picture level, 4 additional RD checks added for each to-be-tested QP value: insert inter with different IMV (0~3) and LIC as to-be-tested modes.

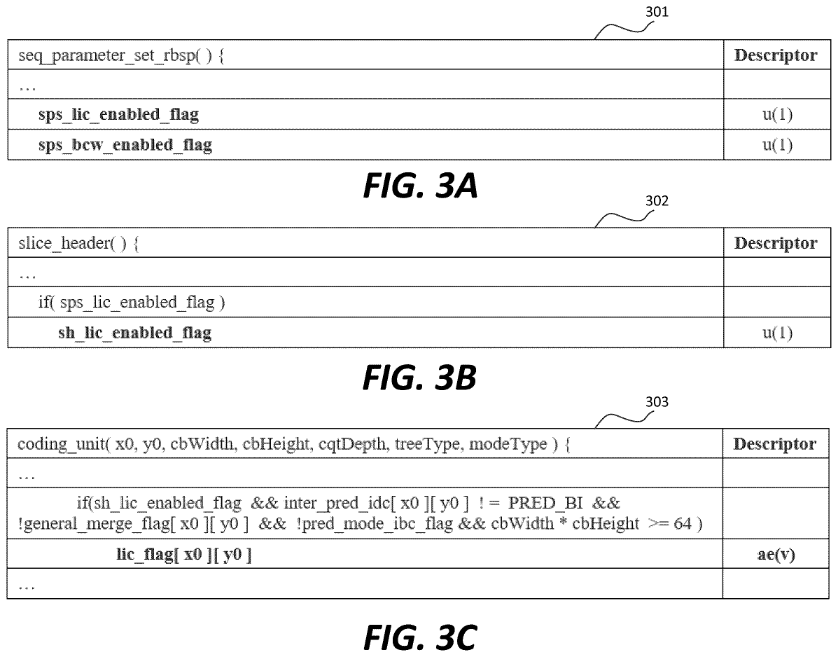

FIGS. 3A-3C shows three syntax tables 301-303 for an LIC mode, respectively, according to embodiments of the disclosure. In the table 301 of FIG. 3A, sps_lic_enabled_flag equal to 0 specifies that the local illumination compensation is disabled. sps_lic_enabled_flag equal to 1 specifies that the local illumination compensation is enabled. In the table 302 of FIG. 3B, sh_lic_enabled_flag equal to 1 specifies that the local illumination compensation is enabled (for example, in a tile group or slice). sh_lic_enabled_flag equal to 0 specifies that the local illumination compensation is disabled (for example, in a tile group or slice). In the table 303 of FIG. 3C, lic_flag [x0][y0] equal to 1 specifies that for the current coding unit, when decoding a P or B tile group or slice, local illumination compensation is used to derive the prediction samples of the current coding unit. lic_flag [x0][y0] equal to 0 specifies that the coding unit is not predicted by applying the local illumination compensation. When lic_flag [x0][y0] is not present, it is inferred to be equal to 0.

### III. Multiple Reference Line LIC (MRL LIC)

Methods (or embodiments) included in this disclosure may be used separately or combined in any order. Further, each of the methods (or embodiments) and apparatuses (e.g., various encoders and decoders) may be implemented by processing circuitry (e.g., one or more processors or one or more integrated circuits). In one example, the one or more processors execute a program that is stored in a non-transitory computer-readable medium. In the disclosure, the term block may be interpreted as a prediction block, a coding block, or a CU.

It is noted in FIGS. 2B and 2C, only one line of samples on top and/or left side of the current and reference CUs are used for estimating (or computing or calculating) the LIC scale and offset parameters. If one side is available and the other side is not available, samples for the available side can only be used for the LIC parameters estimation (or computation or calculation). In this case, the LIC parameters estimation may not be precise, especially for a small CU with only one side of template available.

This disclosure provides embodiments of using multiple reference lines (MRLs) for the LIC parameters estimation to improve the precision of the estimation.

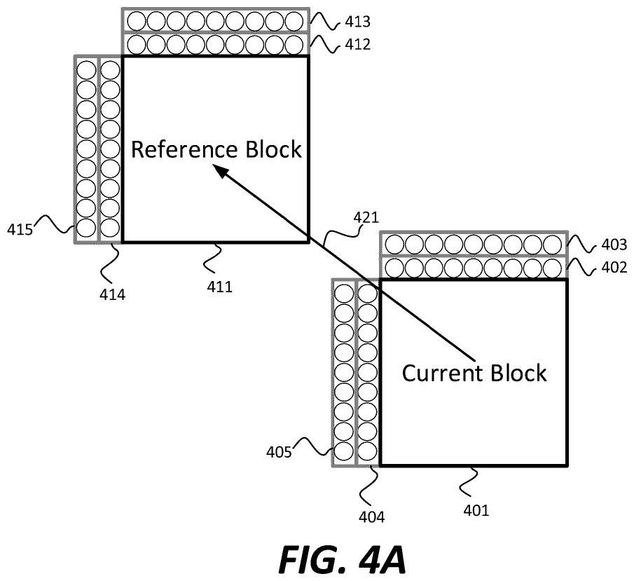

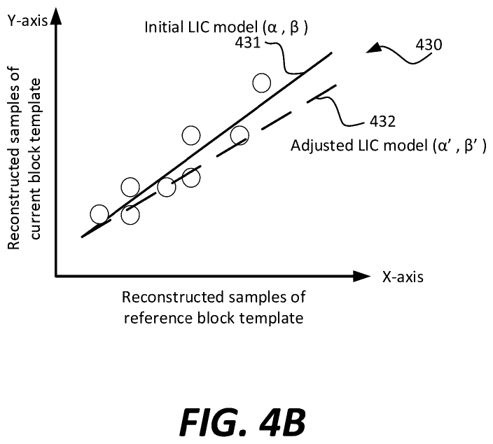

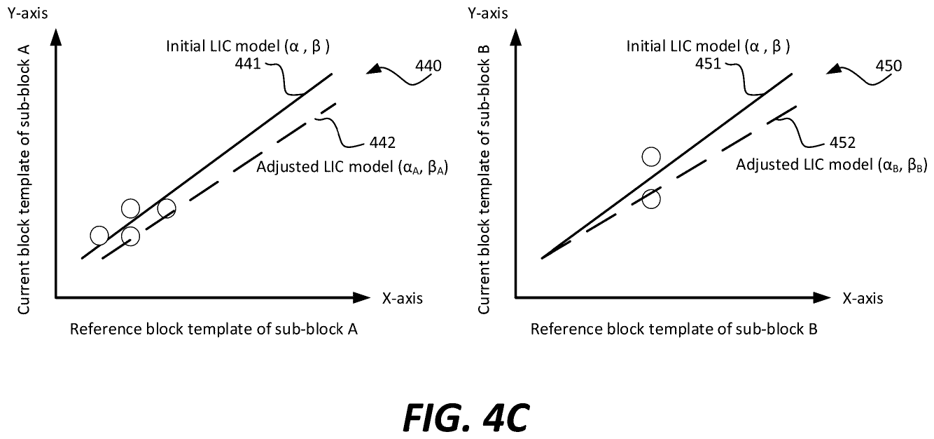

FIG. 4A shows an example of deriving an LIC model using MRLs according to embodiments of the disclosure. In FIG. 4A, an MV 421 points from a current block 401 to a reference block 411, and multiple reference lines can be available for the LIC parameters estimation (e.g., the slope and offset parameters). For example, reference lines 402-403 can be available to be used in a top reference template of the current block 401, reference lines 404-405 can be available to be used in a left reference template of the current block 401, reference lines 412-413 can be available to be used in a top reference template of the reference block 411, and reference lines 414-415 can be available to be used in a left reference template of the reference block 411.

In an embodiment, it can be implicitly or explicitly determined that the MRL LIC is enabled. In an example, whether the MRL LIC is enabled can be explicitly determined based on a first syntax element defined in a bitstream. The first syntax element can be encoded into the bitstream or decoded from the bitstream. For example, the first syntax element defined in the bitstream can be at a sequence level such as sequence parameter set (SPS), a frame level, a picture level such as picture parameter set (PPS) or picture header (PH), a slice level such as slice header (SH), a CTU level, a CU level, a CB level, a TU level, and/or the like. In an example, whether the MRL LIC is enabled can be implicitly determined based on, for example, a block size and/or a number of samples of a current block. In an example, when one of the left or top templates is not available, the MRL LIC can be determined to be enabled. In an example, a sum of absolute differences (SAD) is between samples of a reference block template and samples of a current block template can be calculated. In the FIG. 2B example, the SAD can be calculated based on first reference lines of the reference block template and the current block template. For MRL LIC, the SAD can be calculated based on one or more non-first reference lines of the reference block and the current block. Accordingly, whether to enable the MRL LIC can be implicitly determined based on a comparison between the SAD calculated based on the first reference lines and the SAD calculated based on the one or more non-first reference lines. The implicitly determining whether to enable the MRL LIC can be done at both encoder side and decoder side, and thus no additional signaling is required and the reference lines can be defined implicitly.

In an embodiment, whether to enable MRL LIC or not can be defined at both the encoder and decoder sides. Thus, no signaling is needed in the bitstream. In addition, a syntax element can be signaled at various levels (e.g., SPS, PPS, SH, block level, or the like) to explicitly determine whether to enable MRL LIC or not.

In an embodiment, a combination of explicit and implicit methods can be used to determine whether to enable MRL LIC or not. For example, a syntax element is signaled at a high level (e.g., at an SPS, PH, or SH level) and the determining whether to enable MRL LIC can be implicitly performed at low level (e.g., at a CTU, CU, or CB level).

In an embodiment, up to N reference lines on the top side and/or left side of the current block 401 (and the reference block 411) can be available for the LIC parameters estimation. For example, N can be equal to 2, 3, or 4. In the FIG. 4A example, N is equal to 2. In one example, N can vary depending on one or more conditions, e.g., a block size of the current block 401.

In an embodiment, a number of reference lines available and/or a number of reference lines used for the LIC parameters estimation can be implicitly or explicitly determined. In an example, the number of reference lines available for the LIC parameters estimation can be explicitly determined based on a second syntax element defined in the bitstream and/or the number of reference lines used for the LIC parameters estimation can be explicitly determined based on a third syntax element defined in the bitstream. The second syntax element and/or the third syntax element can be at a sequence level such as SPS, a frame level, a picture level such as PPS or PH, a slice level such as SH, a CTU level, a CU level, a CB level, a TU level, and/or the like. In an example, the number of reference lines available and/or the number of reference lines used for the LIC parameters estimation can be implicitly determined based on, for example, a size and/or a number of samples of a current block. For example, the number of reference lines available and/or the number of reference lines used for the LIC parameters estimation can be increased as the size of the current block decreases. In an example, the number of reference lines available and/or the number of reference lines used for the LIC parameters estimation can be implicitly determined based on an SAD calculated between samples of a reference block template and samples of a current block template. When an SAD calculated based on a block template is the least (or greatest) SAD or less (or greater) than an SAD threshold, the block template can be used as the current block template. The implicitly determining the number of reference lines available and/or the number of reference lines used for the LIC parameters estimation can be done at both encoder side and decoder side, and thus no additional signaling is required and the reference lines can be defined implicitly.

In an embodiment, one or more reference lines used for the LIC parameters estimation can be chosen from the available multiple reference lines 402-403 (or 412-413) for each of the top and/or left reference templates of the current block 401 (or the reference block 411).

In an embodiment, the one or more reference lines for each of the top and left templates can be chosen separately. That is, choosing the one or more reference lines for the top template can be independent from choosing the one or more reference lines for the left template. In an example, in a first combination, the reference line 402 can be chosen for the top template of the current block and the reference lines 404 can be chosen for the left template of the current block. In an example, in a second combination, the reference line 402 can be chosen for the top template of the current block and the reference lines 405 can be chosen for the left template of the current block. In an example, in a third combination, the reference line 403 can be chosen for the top template of the current block and the reference lines 405 can be chosen for the left template of the current block. In an example, in a fourth combination, the reference line 403 can be chosen for the top template of the current block and the reference lines 404 can be chosen for the left template of the current block.

In an embodiment, a first number of the one or more reference lines for the top template can be different from a second number of the one or more reference lines for the left template. In the FIG. 4A example, one of the first and second numbers can be 1 and the other one can be 2. In an example, in a fifth combination, one of the reference lines 402-403 can be chosen for the top template of the current block and both the reference lines 412-413 can be chosen for the left template of the current block. In an example, in a sixth combination, both the reference lines 402-403 can be chosen for the top template of the current block and one of the reference lines 412-413 can be chosen for the left template of the current block.

In an embodiment, the one or more reference lines for each of the top and left templates can be chosen together. In an example, in a seventh combination, the reference lines 402 and 404 can be chosen for the top and left templates of the current block, respectively since the distances from the reference lines 402 and 404 (which are chosen for the top and left templates of the current block) to the current block 401 are the same. In an example, in an eighth combination, the reference lines 403 and 405 can be chosen for the top and left templates of the current block, respectively. In an example, in a ninth combination, the reference lines 402-403 and 404-405 can be chosen for the top and left templates of the current block, respectively.

In an embodiment, two or more above combinations of the reference lines can be first tested and compared, and one of the two or more combinations can then be chosen for the top and left templates.

In an embodiment, the multiple reference lines available for the LIC parameters estimation can be combined, and all or a subset of the samples from the multiple reference lines can be used for the LIC parameters estimation. In an example, the multiple reference lines are available, and then only one reference line can be chosen for each of the top and/or left templates for the LIC parameters estimation. In an example, when a size (or a width or a height) of the current block is greater (or less) than a threshold, a subset of the samples from the multiple reference lines can be used for the LIC parameters estimation. For example, for a 4×8 block and the threshold is 8, one reference line can be used for the samples adjacent to the side of 8 and multiple reference lines can be used for the samples adjacent to the size of 4.

In an embodiment, all three components (i.e., one luma component and two chroma components) can share the same decision for the reference line(s) for the LIC parameters estimation. That is, the same reference line(s) chosen for the LIC parameters estimation can be applied to all the three color components.

In an embodiment, the luma and chroma components can have different reference lines. In an example, only the luma component can have option to use multiple reference lines for the LIC parameters estimation, and each chroma component uses a single reference line for the LIC parameters estimation. In an example, one chroma component can follow the reference line decision for the luma component. That is, the reference line(s) chosen for the luma component can be applied to the one chroma component. In an example, both chroma components can share the same reference line(s) for the LIC parameters estimation.

In an embodiment, a fourth syntax element can be implicitly or explicitly defined in the bitstream to indicate that same reference line(s) can be shared among the three color components or between the two chroma components or between the luma component and one chroma component.

In an embodiment, one or more chosen reference lines can be implicitly or explicitly defined in the bitstream at a decoder side.

In an embodiment, an additional processing can be applied to the multiple reference lines available and/or the one or more chosen reference lines for the LIC parameters estimation. For example, a sub-sampling, a filtering, and/or an averaging can be applied to the samples of the multiple available reference lines and/or the one or more chosen reference lines.

In an embodiment, the multiple reference lines can be available for the LIC parameters estimation in a CU (e.g., the current block 401) that is not located at the top of a CTU row and/or a virtual pipeline data unit (VPDU).

In an embodiment, the multiple reference lines can be available for the LIC parameters estimation when only one of the top and left templates of the current block 401 is not available for the LIC parameters estimation.

In an embodiment, more than one LIC model (or more than one set of the LIC scale and offset parameters) can be estimated (or computed) when the multiple reference lines of the top and/or left templates are available for the LIC parameters estimation. For example, a separate LIC model can be computed for each of the top and left available reference lines of the current block 401. A first LIC model can be computed when the reference lines 402 and 404 are used for the top and left templates of the current block 401, and a second LIC model can be computed when the reference lines 403 and 413 are used for the top and left templates of the current block 401. A final LIC model can be determined based on, for example, a weighted average of the first and second models. In an example, after the more than one LIC model is estimated, one of the more than one LIC model can be selected by an encoder, and a syntax element indicating the selected one can be signaled to a decoder. In an example, after the more than one LIC model is estimated, one of the more than one LIC model can be implicitly determined by a decoder. For example, multiple sets of LIC scale and offset can be obtained (or computed), based on different reference lines, and then can be applied to all the available multiple reference lines. One of the multiple sets providing the minimum sum of squared differences and/or the minimum sum of absolute differences between the current template with LIC applied and the reference template using all available multiple reference lines for computing SSD/SAD can be selected. In such an example, no additional signaling is needed since the selection of the one of the multiple sets can be done at both the encoder and decoder.

In an embodiment, the samples from all available lines for the LIC parameters estimation can be split into multiple categories (or groups) and the samples from each category can be used for the LIC parameters estimation. In an example, a weighted average of all available samples in the template can be computed and the weighted average can be used as a threshold to split all the samples into groups. In an example, when a number of the groups is equal to 2, all the samples can be split into a first group in which the samples are greater than or equal to the threshold and a second group in which the samples are smaller than the threshold. In an example, the threshold can be a predefined value. In an example, the threshold can be dependent on one or more criteria (e.g., a block size, a color component, a temporal layer index TId, and the like). In an example, the samples from the top and/or left templates of a current CU (e.g., the current block 401) are compared to the threshold and one of the multiple LIC models (or sets of the LIC scale and offset parameters) can be chosen based on one or more criteria. In an example, one of the one or more criteria can be whether the samples are greater than or equal to the threshold.

In an embodiment, the LIC scale (or offset) values in the multiple sets of scale and offset parameters can be combined into one value based on a predefined rule. In an example, a weighted average of the multiple LIC scale (or offset) values can be computed and used as a candidate for a final scale (or offset) value.

In an embodiment, the LIC scale and offset values can be calculated (or defined) multiple times. In an example, an iterative approach can be applied to calculate the LIC scale and offset values. In an example, a first set of LIC scale and offset values can be calculated and applied to the current block template. The current block template can then be compared to the reference template using a criteria, for example, that the samples with the largest error (and/or other samples if needed) can be discarded. Then, another round of the LIC parameters estimation can be performed and a second set of LIC scale and offset values can be calculated. In an example, more than one round of refinement process of the LIC parameters can be performed, and the LIC parameters of a final round of refinement process can be used in the final LIC model.

### IV. Parameter Adjustment for LIC

In the FIG. 2A example, only one set of parameters (i.e., LIC scale α and offset β) can be estimated for a current to-be-coded CU.

This disclosure provides embodiments of estimating one or more parameter adjustment values to adjust a slope α and/or an offset β of an LIC model.

FIG. 4B shows an example of adjusting a slope parameter of an LIC model according to embodiments of the disclosure. In the plot 430, a set of scale α and offset β can be calculated to generate an initial LIC model 431. Then, the scale α can be adjusted as an adjusted slope α′ based on a slope adjustment value to generate an adjusted LIC model 432.

In an embodiment, the slope adjustment value can be estimated at an encoder and signaled to a decoder. In an embodiment, the slope adjustment value can be estimated at both the encoder and decoder, so no additional signaling is required.

In an embodiment, the slope adjustment value can be based on a predefined set of adjustment values (e.g., +/−0.95, +/−0.8, or +/−0.6). In an example, the slope adjustment value can be added to the slope α. In an example, the slope α can be multiplied by the slope adjustment value.

In an embodiment, a combination of the adjusted slope α′ with the offset β can be tested and then an option providing the best result in terms of one or more criteria can be chosen. In an example, the option providing the best result in terms of the one or more criteria (for example, the combination of the adjusted slope α′ with the offset β which provide the best (for example, smallest or largest) SAD, SSD (sum of squared differences), SATD (sum of absolute transformed differences) or any other analytic parameter) can be signaled to the decoder. In an example, all possible combinations can be tested at both the encoder and decoder, and the option providing the best result in terms of the one or more criteria can be defined without any additional signaling. For example, multiple combination of adjusted slope α′ with the offset β can be obtained (or computed), based on different reference lines, and then can be applied to all the available multiple reference lines. One of the multiple combinations providing the minimum sum of squared differences and/or the minimum sum of absolute differences between the current template with LIC applied and the reference template using all available multiple reference lines for computing SSD/SAD can be chosen.

In an embodiment, the adjustment steps can be predefined. In an example, an angle θ between the line y=α*p[x]+β and the horizontal or vertical axes can be adjusted as θ′. Then, it is calculated that α′=tan(θ′) and β′=y₀−α′x₀, where x₀ and y₀ are coordinates of crossing points of the original line y=α*p[x]+β and adjusted line y=α′*p[x]+β′. In an example, the adjustment of the angle θ can be skipped, and the slope parameter α can be directly adjusted as α′, based on which the adjusted offset parameter β′ can be obtained.

In an embodiment, the slope adjustment value can be dependent on one or more criteria, e.g., a block size, a relation/correspondence between a block width and a block height, and the like. In an example, different adjustment values can be applied for different block sizes/areas. For a small block, a small (set of) adjustment value(s) can be applied; and for a large block, a large (set of) adjustment value(s) can be applied.

In an embodiment, the slope adjustment value can be signaled for each color component separately. In an example, the slope adjustment value can be signaled only for one color component (e.g., Y). In an example, the slope adjustment value can be shared between multiple color components (e.g., Cb and Cr can share the same slope adjustment). In an example, the slope adjustment value can be derived (or calculated) only once and then shared among all color components (e.g., the slope adjustment value is defined or calculated for Y component and shared among all the Y, Cb, and Cr components).

In an embodiment, a fifth syntax element can be implicitly or explicitly defined in the bitstream to indicate whether signaling the slope adjustment value is enabled. In an example, the fifth syntax element can be implicitly or explicitly defined in the bitstream at a sequence level (e.g., SPS), a frame level, a picture level, a slice level, a CTU level, a CU level, or a PU level (e.g., PPS or PH or SH).

It is noted that the above embodiments can also be applied to determine an offset adjustment value to adjust the offset β of the LIC model.

### V. Parameter Adjustment for Sub-Block LIC

In the FIG. 2C example, for a sub-block LIC mode, a reference template of the current block 228 is constructed based on all subblocks A-G neighboring (or adjacent) to the top and/or left borders of the current block 228, and then the LIC parameters are computed, which are then applied to all the subblocks of the current block 228.

This disclosure provides embodiments of estimating a slope (or scale) adjustment value and/or an offset adjustment value for each of one or more sub-blocks of a current block that is coded in a sub-block mode (e.g., affine mode).

FIG. 4C shows two examples of adjusting LIC parameters of sub-blocks according to embodiments of the disclosure. In the FIG. 4C, the plot 440 represents an adjustment of a sub-block A of the current block 228. The initial LIC parameters α and β of the sub-block A can be adjusted as a and BA, so that the initial LIC model 441 can be adjusted as an adjusted LIC model 442. Similar, the plot 450 represents an adjustment of a sub-block B of the current block 228. The initial LIC parameters α and β of the sub-block B can be adjusted as ap and BB, so that the initial LIC model 441 can be adjusted as an adjusted LIC model 442.

In an embodiment, the slope and/or offset of each sub-block of the current block can be adjusted. In an embodiment, a separate adjustment can be defined (or estimated) for each M×N sub-block of the current block. In an example, M and N can be fixed, e.g., M=N=2 or 4. In an example, M and N can depend on one or more criteria, e.g., a block size.

In an embodiment, an adjustment can be estimated using samples from a template of each sub-block of the current block.

In an embodiment, an adjustment value can be chosen from a predefined set of available options.

In an embodiment, multiple adjustment values can be estimated for multiple subblocks of the current block and then are combined into a final candidate value based on a predefined rule such as an averaging algorithm applied to the multiple adjustment values.

In an embodiment, an adjusted value of the LIC scale (or offset) can be applied to each subblock individually, based on a predefined rule. For example, the adjustment value can be applied to one or more subblocks of the current block, based on the predefined rule, for example, based on a position of a sub-block relative to a top-left corner of the current block.

In an embodiment, a scale (or offset) adjustment value can be estimated for a boundary sub-block (that is adjacent to a boundary of the current block) and the adjusted scale (or offset) value can be applied to a non-boundary blocks (that is not adjacent to the boundary of the current block).

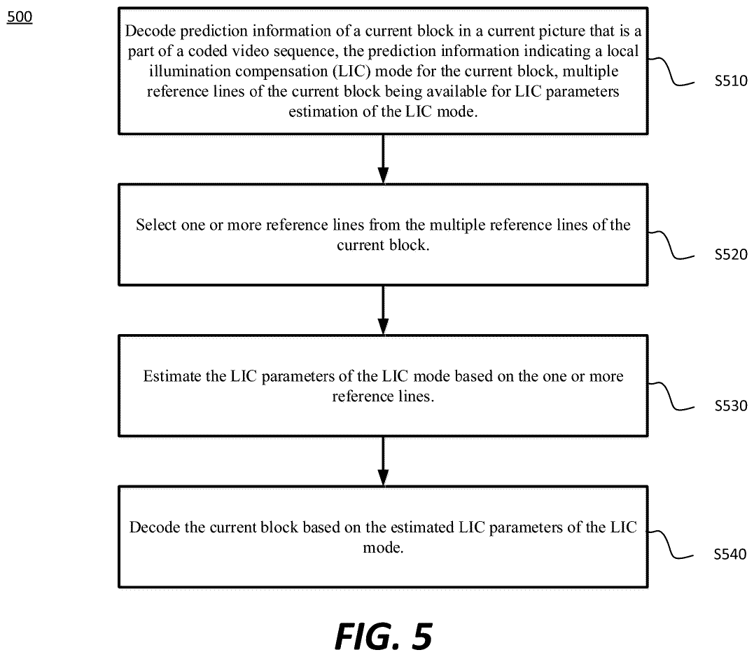

FIG. 5 shows a flow chart outlining a process 500 according to an embodiment of the disclosure. The process 500 can be used in the reconstruction of a block coded in an LIC mode, so to generate a prediction block for the block under reconstruction. In various embodiments, the process 500 can be executed by processing circuitry, such as CPU 841 and/or GPU 842 of the computer system 800. In some embodiments, the process 500 is implemented in software instructions, thus when the processing circuitry executes the software instructions, the processing circuitry performs the process 500. The process can start at S510.

At step S510, the process 500 decodes prediction information of a current block in a current picture that is a part of a coded video sequence. The prediction information indicates an LIC mode for the current block. Multiple reference lines of the current block are available for LIC parameters estimation of the LIC mode. Then, the process 500 proceeds to step S520.

At step S520, the process 500 selects one or more reference lines from the multiple reference lines of the current block. Then, the process 500 proceeds to step S530.

At step S530, the process 500 estimates the LIC parameters of the LIC mode based on the one or more reference lines. Then, the process 500 proceeds to step S540.

At step S540, the process 500 decodes the current block based on the estimated LIC parameters of the LIC mode. Then, the process 500 terminates.

In an embodiment, the prediction information includes a first syntax element indicating that the multiple reference lines of the current block are available for the LIC parameters estimation of the LIC mode.

In an embodiment, the prediction information includes a second syntax element indicating a number of the multiple reference lines available for the LIC parameters estimation of the LIC mode.

In an embodiment, the prediction information includes a third syntax element indicating a number of the one or more reference lines selected for the LIC parameters estimation of the LIC mode.

In an embodiment, the one or more reference lines includes a first subset and a second subset of the multiple reference lines for a top reference template and a left reference template of the current block, respectively. The first subset of the multiple reference lines is different from the second subset of the multiple reference lines.

In an embodiment, the one or more reference lines includes a first subset and a second subset of the multiple reference lines for a luma component and a chroma component of the current block, respectively. The first subset of the multiple reference lines is different from the second subset of the multiple reference lines.

In an embodiment, the one or more reference lines includes a subset of the multiple reference lines that is applied to at least two of one luma component and two chroma components of the current block. The prediction information includes a fourth syntax indicating the subset of the multiple reference lines.

In an embodiment, the prediction information indicates the one or more selected reference lines.

According to some embodiments of the disclosure, the process 500 calculates multiple sets of the LIC parameters based on the one or more reference lines and determines the LIC parameters of the LIC mode based on at least one of the multiple sets of the LIC parameters.

In an embodiment, the process 500 calculates a separate one of the multiple sets of the LIC parameters for each of the one or more reference lines. The process 500 determines the LIC parameters of the LIC mode based on a weighted average of the multiple sets of the LIC parameters.

In an embodiment, the process 500 splits samples of the one or more reference lines into a plurality of groups of samples based on a criteria such as a threshold and calculates the multiple sets of the LIC parameters based on the plurality of groups of samples. The process 500 selects one of the multiple sets of the LIC parameters as the LIC parameters of the LIC mode.

In an embodiment, the process 500 calculates the multiple sets of the LIC parameters based on multiple rounds of refinement process on the LIC parameters. The process 500 determines the LIC parameters of a final round of the multiple rounds as the LIC parameter of the LIC model.

According to some embodiments of the disclosure, the process 500 calculates a slope parameter of the LIC model based on the one or more reference lines and adjusts the slope parameter based on a slope adjustment value.

In an embodiment, the slope adjustment value is selected from a predefined set of adjustment values.

In an embodiment, the slope adjustment value is signaled in the prediction information.

In an embodiment, the prediction includes a fifth syntax element indicating whether signaling the slope adjustment value is enabled.

According to some embodiments of the disclosure, the current block is coded in a sub-block mode, and the process 500 calculates the LIC parameters for each sub-block of the current block and adjusts the LIC parameters of each sub-block based on at least one LIC parameter adjustment value.

In an embodiment, the process 500 determines multiple adjustment values each for a separate sub-block and determines a final candidate value based on the multiple adjustment values.

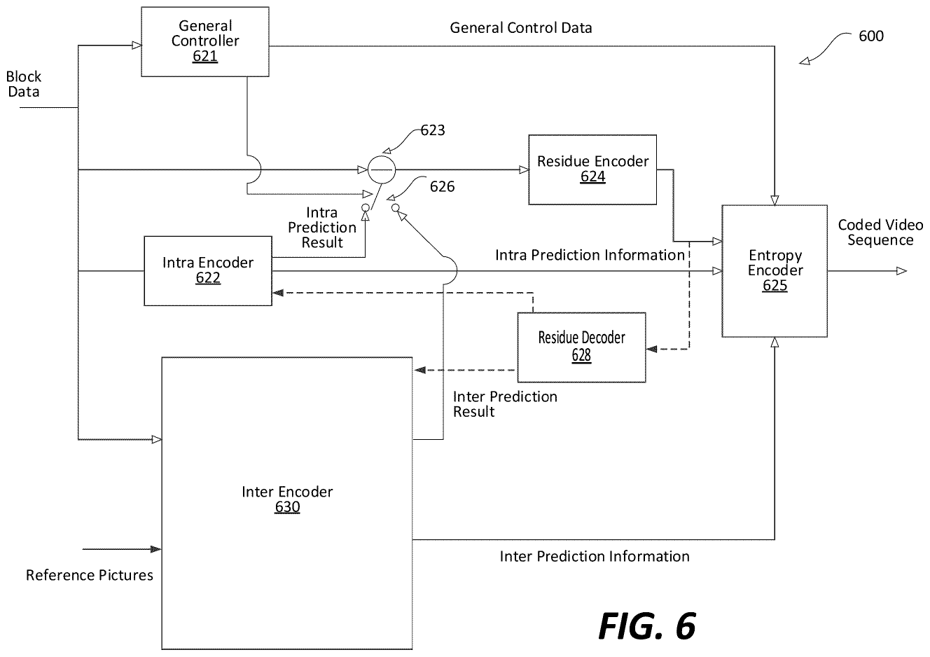

FIG. 6 shows a diagram of a video encoder 600 according to embodiments of the disclosure. The video encoder 600 is configured to receive a processing block (e.g., a prediction block) of sample values within a current video picture in a sequence of video pictures, and encode the processing block into a coded picture that is part of a coded video sequence.

In an example, the video encoder 600 receives a matrix of sample values for a processing block, such as a prediction block of 8×8 samples, and the like. The video encoder 600 determines whether the processing block is best coded using intra mode, inter mode, or bi-prediction mode using, for example, rate-distortion optimization. When the processing block is to be coded in intra mode, the video encoder 600 may use an intra prediction technique to encode the processing block into the coded picture; and when the processing block is to be coded in inter mode or bi-prediction mode, the video encoder 600 may use an inter uni-prediction or bi-prediction technique, respectively, to encode the processing block into the coded picture. In certain video coding technologies, merge mode can be an inter picture prediction submode where the motion vector is derived from one or more motion vector predictors without the benefit of a coded motion vector component outside the predictors. In certain other video coding technologies, a motion vector component applicable to the subject block may be present. In an example, the video encoder 600 includes other components, such as a mode decision module (not shown) to determine the mode of the processing blocks.

In the FIG. 6 example, the video encoder 600 includes the inter encoder 630, an intra encoder 622, a residue calculator 623, a switch 626, a residue encoder 624, a general controller 621, and an entropy encoder 625 coupled together as shown in FIG. 6.

The inter encoder 630 is configured to receive the samples of the current block (e.g., a processing block), compare the block to one or more reference blocks in reference pictures (e.g., blocks in previous pictures and later pictures), generate inter prediction information (e.g., description of redundant information according to inter encoding technique, motion vectors, merge mode information), and calculate inter prediction results (e.g., predicted block) based on the inter prediction information using any suitable technique. In some examples, the reference pictures are decoded reference pictures that are decoded based on the encoded video information.

The intra encoder 622 is configured to receive the samples of the current block (e.g., a processing block), in some cases compare the block to blocks already coded in the same picture, generate quantized coefficients after transform, and in some cases also intra prediction information (e.g., an intra prediction direction information according to one or more intra encoding techniques). In an example, the intra encoder 622 also calculates intra prediction results (e.g., predicted block) based on the intra prediction information and reference blocks in the same picture.

The general controller 621 is configured to determine general control data and control other components of the video encoder 600 based on the general control data. In an example, the general controller 621 determines the mode of the block, and provides a control signal to the switch 626 based on the mode. For example, when the mode is the intra mode, the general controller 621 controls the switch 626 to select the intra mode result for use by the residue calculator 623, and controls the entropy encoder 625 to select the intra prediction information and include the intra prediction information in the bitstream; and when the mode is the inter mode, the general controller 621 controls the switch 626 to select the inter prediction result for use by the residue calculator 623, and controls the entropy encoder 625 to select the inter prediction information and include the inter prediction information in the bitstream.

The residue calculator 623 is configured to calculate a difference (residue data) between the received block and prediction results selected from the intra encoder 622 or the inter encoder 630. The residue encoder 624 is configured to operate based on the residue data to encode the residue data to generate the transform coefficients. In an example, the residue encoder 624 is configured to convert the residue data from a spatial domain to a frequency domain, and generate the transform coefficients. The transform coefficients are then subject to quantization processing to obtain quantized transform coefficients. In various embodiments, the video encoder 600 also includes a residue decoder 628. The residue decoder 628 is configured to perform inverse-transform, and generate the decoded residue data. The decoded residue data can be suitably used by the intra encoder 622 and the inter encoder 630. For example, the inter encoder 630 can generate decoded blocks based on the decoded residue data and inter prediction information, and the intra encoder 622 can generate decoded blocks based on the decoded residue data and the intra prediction information. The decoded blocks are suitably processed to generate decoded pictures and the decoded pictures can be buffered in a memory circuit (not shown) and used as reference pictures in some examples.

The entropy encoder 625 is configured to format the bitstream to include the encoded block. The entropy encoder 625 is configured to include various information according to a suitable standard, such as the HEVC standard, VVC or any other video coding standard. In an example, the entropy encoder 625 is configured to include the general control data, the selected prediction information (e.g., intra prediction information or inter prediction information), the residue information, and other suitable information in the bitstream. Note that, according to the disclosed subject matter, when coding a block in the merge submode of either inter mode or bi-prediction mode, there is no residue information.

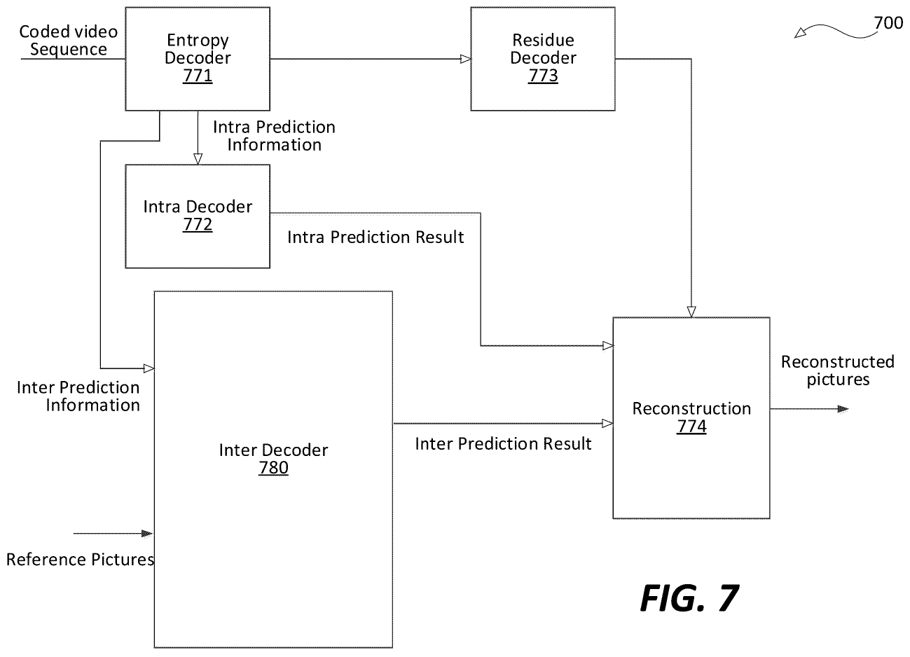

FIG. 7 shows a diagram of a video decoder 700 according to embodiments of the disclosure. The video decoder 700 is configured to receive coded pictures that are part of a coded video sequence, and decode the coded pictures to generate reconstructed pictures.

In the FIG. 7 example, the video decoder 700 includes an entropy decoder 771, an inter decoder 780, a residue decoder 773, a reconstruction module 774, and an intra decoder 772 coupled together as shown in FIG. 7.

The entropy decoder 771 can be configured to reconstruct, from the coded picture, certain symbols that represent the syntax elements of which the coded picture is made up. Such symbols can include, for example, the mode in which a block is coded (such as, for example, intra mode, inter uni-directional prediction mode, inter bi-predicted mode, the latter two in merge submode or another submode), prediction information (such as, for example, intra prediction information or inter prediction information) that can identify certain sample or metadata that is used for prediction by the intra decoder 772 or the inter decoder 780, respectively, residual information in the form of, for example, quantized transform coefficients, and the like. In an example, when the prediction mode is inter or bi-predicted mode, the inter prediction information is provided to the inter decoder 780; and when the prediction type is the intra prediction type, the intra prediction information is provided to the intra decoder 772. The residual information can be subject to inverse quantization and is provided to the residue decoder 773.

The inter decoder 780 is configured to receive the inter prediction information, and generate inter prediction results based on the inter prediction information.

The intra decoder 772 is configured to receive the intra prediction information, and generate prediction results based on the intra prediction information.

The residue decoder 773 is configured to perform inverse quantization to extract de-quantized transform coefficients, and process the de-quantized transform coefficients to convert the residual from the frequency domain to the spatial domain. The residue decoder 773 may also require certain control information (to include the Quantizer Parameter (QP)), and that information may be provided by the entropy decoder 771 (data path not depicted as this may be low volume control information only).

The reconstruction module 774 is configured to combine, in the spatial domain, the residual as output by the residue decoder 773 and the prediction results (as output by the inter or intra prediction modules as the case may be) to form a reconstructed block, that may be part of the reconstructed picture, which in turn may be part of the reconstructed video. It is noted that other suitable operations, such as a deblocking operation and the like, can be performed to improve the visual quality.

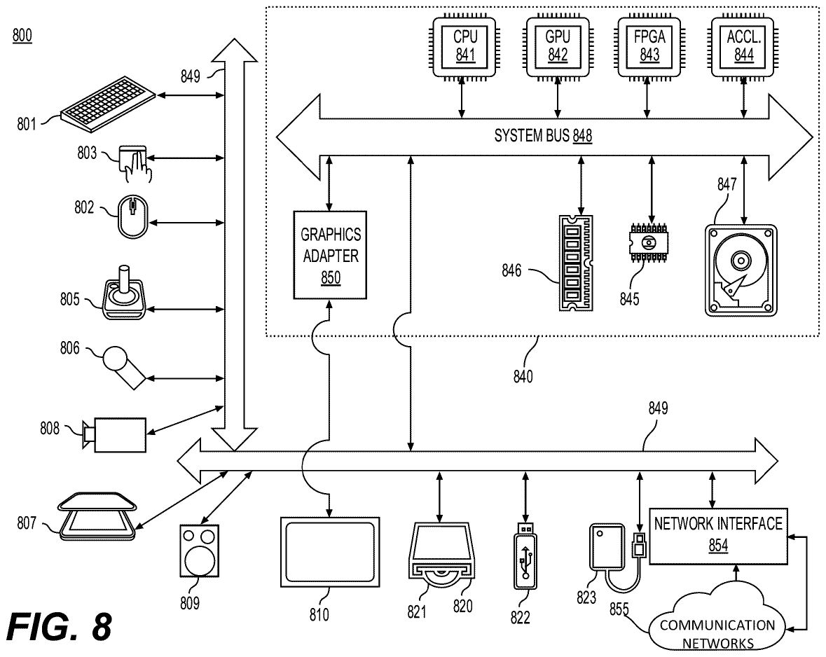

The techniques described above, can be implemented as computer software using computer-readable instructions and physically stored in one or more computer-readable media. For example, FIG. 8 shows a computer system 800 suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 8 for computer system 800 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system 800.

Computer system 800 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 801, mouse 802, trackpad 803, touch screen 810, data-glove (not shown), joystick 805, microphone 806, scanner 807, and camera 808.

Computer system 800 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 810, data-glove (not shown), or joystick 805, but there can also be tactile feedback devices that do not serve as input devices), audio output devices (such as: speakers 809, headphones (not depicted)), visual output devices (such as screens 810 to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted). These visual output devices (such as screens 810) can be connected to a system bus 848 through a graphics adapter 850.

Computer system 800 can also include human accessible storage devices and their associated media such as optical media including CD/DVD ROM/RW 820 with CD/DVD or the like media 821, thumb-drive 822, removable hard drive or solid state drive 823, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 800 can also include a network interface 854 to one or more communication networks 855. The one or more communication networks 855 can for example be wireless, wireline, optical. The one or more communication networks 855 can further be local, wide-area, metropolitan, vehicular and industrial, real-time, delay-tolerant, and so on. Examples of the one or more communication networks 855 include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses 849 (such as, for example USB ports of the computer system 800; others are commonly integrated into the core of the computer system 800 by attachment to a system bus as described below (for example Ethernet interface into a PC computer system or cellular network interface into a smartphone computer system). Using any of these networks, computer system 800 can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core 840 of the computer system 800.

The core 840 can include one or more Central Processing Units (CPU) 841, Graphics Processing Units (GPU) 842, specialized programmable processing units in the form of Field Programmable Gate Areas (FPGA) 843, hardware accelerators for certain tasks 844, graphics adapters 850, and so forth. These devices, along with Read-only memory (ROM) 845, Random-access memory 846, internal mass storage 847 such as internal non-user accessible hard drives, SSDs, and the like, may be connected through the system bus 848. In some computer systems, the system bus 848 can be accessible in the form of one or more physical plugs to enable extensions by additional CPUs, GPU, and the like. The peripheral devices can be attached either directly to the core's system bus 848, or through a peripheral bus 849. In an example, the screen 810 can be connected to the graphics adapter 850. Architectures for a peripheral bus include PCI, USB, and the like.

CPUs 841, GPUs 842, FPGAs 843, and accelerators 844 can execute certain instructions that, in combination, can make up the aforementioned computer code. That computer code can be stored in ROM 845 or RAM 846. Transitional data can be also be stored in RAM 846, whereas permanent data can be stored for example, in the internal mass storage 847. Fast storage and retrieve to any of the memory devices can be enabled through the use of cache memory, that can be closely associated with one or more CPU 841, GPU 842, mass storage 847, ROM 845, RAM 846, and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture 800 and specifically the core 840 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 840 that are of non-transitory nature, such as core-internal mass storage 847 or ROM 845. The software implementing various embodiments of the present disclosure can be stored in such devices and executed by core 840. A computer-readable medium can include one or more memory devices or chips, according to particular needs. The software can cause the core 840 and specifically the processors therein (including CPU, GPU, FPGA, and the like) to execute particular processes or particular parts of particular processes described herein, including defining data structures stored in RAM 846 and modifying such data structures according to the processes defined by the software. In addition or as an alternative, the computer system can provide functionality as a result of logic hardwired or otherwise embodied in a circuit (for example: accelerator 844), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

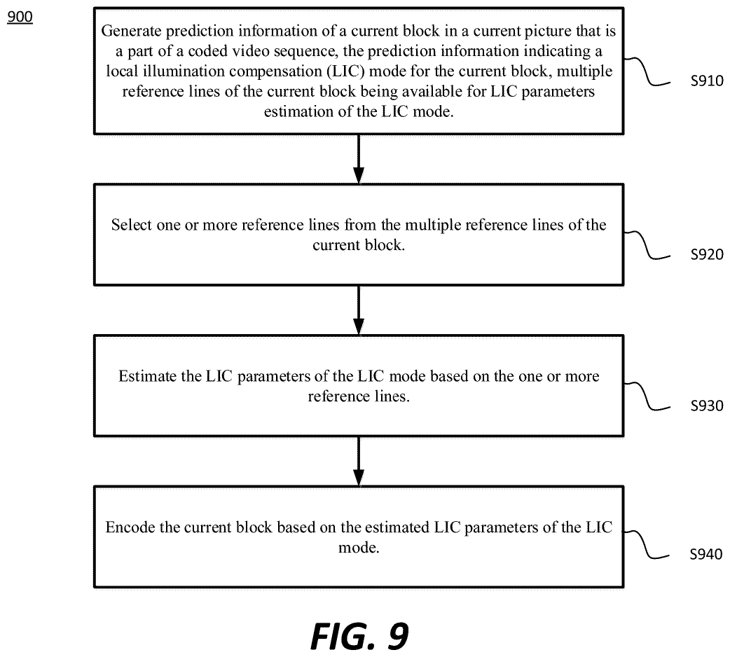

FIG. 9 shows a flow chart outlining a process 900 according to an embodiment of the disclosure. The process 900 can be used in encoding a to-be-coded block using an LIC mode. In various embodiments, the process 900 can be executed by processing circuitry, such as CPU 841 and/or GPU 842 of the computer system 800. In some embodiments, the process 900 is implemented in software instructions, thus when the processing circuitry executes the software instructions, the processing circuitry performs the process 900. The process can start at S910.

At step S910, the process 900 generates prediction information of a current block in a current picture that is a part of a coded video sequence. The prediction information indicates an LIC mode for the current block. Multiple reference lines of the current block are available for LIC parameters estimation of the LIC mode. Then, the process proceeds to step S920.

At step S920, the process 900 selects one or more reference lines from the multiple reference lines of the current block. Then, the process 900 proceeds to step S930.

At step S930, the process 900 estimates the LIC parameters of the LIC mode based on the one or more reference lines. Then, the process 900 proceeds to step S940.

At step S940, the process 900 encodes the current block based on the estimated LIC parameters of the LIC mode. Then, the process 900 terminates.

In an embodiment, the prediction information includes a first syntax element indicating that the multiple reference lines of the current block are available for the LIC parameters estimation of the LIC mode.

In an embodiment, the prediction information includes a second syntax element indicating a number of the multiple reference lines available for the LIC parameters estimation of the LIC mode.

In an embodiment, the prediction information includes a third syntax element indicating a number of the one or more reference lines selected for the LIC parameters estimation of the LIC mode.

In an embodiment, the one or more reference lines includes a first subset and a second subset of the multiple reference lines for a top reference template and a left reference template of the current block, respectively. The first subset of the multiple reference lines is different from the second subset of the multiple reference lines.

In an embodiment, the one or more reference lines includes a first subset and a second subset of the multiple reference lines for a luma component and a chroma component of the current block, respectively. The first subset of the multiple reference lines is different from the second subset of the multiple reference lines.

In an embodiment, the one or more reference lines includes a subset of the multiple reference lines that is applied to at least two of one luma component and two chroma components of the current block. The prediction information includes a fourth syntax indicating the subset of the multiple reference lines.

In an embodiment, the prediction information indicates the one or more selected reference lines.

According to some embodiments of the disclosure, the process 900 calculates multiple sets of the LIC parameters based on the one or more reference lines and determines the LIC parameters of the LIC mode based on at least one of the multiple sets of the LIC parameters.

In an embodiment, the process 900 calculates a separate one of the multiple sets of the LIC parameters for each of the one or more reference lines. The process 900 determines the LIC parameters of the LIC mode based on a weighted average of the multiple sets of the LIC parameters.

In an embodiment, the process 900 splits samples of the one or more reference lines into a plurality of groups of samples based on a criteria such as a threshold and calculates the multiple sets of the LIC parameters based on the plurality of groups of samples. The process 900 selects one of the multiple sets of the LIC parameters as the LIC parameters of the LIC mode.

In an embodiment, the process 900 calculates the multiple sets of the LIC parameters based on multiple rounds of refinement process on the LIC parameters. The process 900 determines the LIC parameters of a final round of the multiple rounds as the LIC parameter of the LIC model.

According to some embodiments of the disclosure, the process 900 calculates a slope parameter of the LIC model based on the one or more reference lines and adjusts the slope parameter based on a slope adjustment value.

In an embodiment, the slope adjustment value is selected from a predefined set of adjustment values.

In an embodiment, the slope adjustment value is signaled in the prediction information.

In an embodiment, the prediction includes a fifth syntax element indicating whether signaling the slope adjustment value is enabled.

According to some embodiments of the disclosure, the current block is coded in a sub-block mode, and the process 900 calculates the LIC parameters for each sub-block of the current block and adjusts the LIC parameters of each sub-block based on at least one LIC parameter adjustment value.

In an embodiment, the process 900 determines multiple adjustment values each for a separate sub-block and determines a final candidate value based on the multiple adjustment values.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method of video coding at a decoder, comprising:
decoding prediction information of a current block in a current picture that is a part of a coded video sequence, the prediction information indicating a local illumination compensation (LIC) mode for the current block, multiple reference lines of the current block being available for LIC parameters estimation of the LIC mode;
selecting one or more reference lines from the multiple reference lines of the current block;
estimating the LIC parameters of the LIC mode based on the one or more reference lines; and
decoding the current block based on the estimated LIC parameters of the LIC mode.

2. The method of claim 1, wherein the prediction information includes a first syntax element indicating that the multiple reference lines of the current block are available for the LIC parameters estimation of the LIC mode.

3. The method of claim 1, wherein the prediction information includes a second syntax element indicating a number of the multiple reference lines available for the LIC parameters estimation of the LIC mode.

4. The method of claim 1, wherein the prediction information includes a third syntax element indicating a number of the one or more reference lines selected for the LIC parameters estimation of the LIC mode.

5. The method of claim 1, wherein the one or more reference lines includes a first subset and a second subset of the multiple reference lines for a top reference template and a left reference template of the current block, respectively, the first subset of the multiple reference lines being different from the second subset of the multiple reference lines.

6. The method of claim 1, wherein the one or more reference lines includes a first subset and a second subset of the multiple reference lines for a luma component and a chroma component of the current block, respectively, the first subset of the multiple reference lines being different from the second subset of the multiple reference lines.

7. The method of claim 1, wherein the one or more reference lines includes a subset of the multiple reference lines that is applied to at least two of one luma component and two chroma components of the current block, and wherein the prediction information includes a fourth syntax indicating the subset of the multiple reference lines.

8. The method of claim 1, wherein the prediction information indicates the one or more selected reference lines.

9. The method of claim 1, wherein the estimating includes:
calculating multiple sets of the LIC parameters based on the one or more reference lines; and
determining the LIC parameters of the LIC mode based on at least one of the multiple sets of the LIC parameters.

10. The method of claim 9, wherein
the calculating includes
calculating a separate one of the multiple sets of the LIC parameters for each of the one or more reference lines, and
the determining includes
determining the LIC parameters of the LIC mode based on a weighted average of the multiple sets of the LIC parameters.

11. The method of claim 9, wherein
the calculating includes
splitting samples of the one or more reference lines into a plurality of groups of samples based on a threshold, and
calculating the multiple sets of the LIC parameters based on the plurality of groups of samples, and
the determining includes
selecting one of the multiple sets of the LIC parameters as the LIC parameters of the LIC mode.

12. The method of claim 9, wherein
the calculating includes
calculating the multiple sets of the LIC parameters based on multiple rounds of refinement process on the LIC parameters, and
the determining includes
determining the LIC parameters of a final round of the multiple rounds as the LIC parameter of the LIC model.

13. The method of claim 1, wherein the estimating includes:
calculating a slope parameter of the LIC model based on the one or more reference lines; and
adjusting the slope parameter based on a slope adjustment value.

14. The method of claim 13, wherein the slope adjustment value is selected from a predefined set of adjustment values.

15. The method of claim 13, wherein the slope adjustment value is signaled in the prediction information.

16. The method of claim 15, wherein the prediction includes a fifth syntax element indicating whether signaling the slope adjustment value is enabled.

17. The method of claim 1, wherein the current block is coded in a sub-block mode, and the estimating includes:
calculating the LIC parameters for each sub-block of the current block; and
adjusting the LIC parameters of each sub-block based on at least one LIC parameter adjustment value.

18. The method of claim 17, wherein the adjusting includes:
determining multiple adjustment values each for a separate sub-block; and
determining a final candidate value based on the multiple adjustment values.

19. An apparatus for video coding, comprising:
processing circuitry configured to
decode prediction information of a current block in a current picture that is a part of a coded video sequence, the prediction information indicating a local illumination compensation (LIC) mode for the current block, multiple reference lines of the current block being available for LIC parameters estimation of the LIC mode;
select one or more reference lines from the multiple reference lines of the current block;
estimate the LIC parameters of the LIC mode based on the one or more reference lines; and
decode the current block based on the estimated LIC parameters of the LIC mode.

20. A method of video coding at an encoder, comprising:
generating prediction information of a current block in a current picture that is a part of a coded video sequence, the prediction information indicating a local illumination compensation (LIC) mode for the current block, multiple reference lines of the current block being available for LIC parameters estimation of the LIC mode;
selecting one or more reference lines from the multiple reference lines of the current block;
estimating the LIC parameters of the LIC mode based on the one or more reference lines; and
encoding the current block based on the estimated LIC parameters of the LIC mode.
